(19) United States
(12) Patent Application Publication
(10) Pub. No.: US 2014/0344923 A1
(43) Pub. Date: Nov. 20, 2014

(54) UNLOCKING METHOD AND DEVICE, PASSWORD SETTING METHOD AND DEVICE

(71) Applicant: Tencent Technology (Shenzhen) Company Limited, Shenzhen (CN)

(72) Inventors: Xiaoou Wang, Shenzhen (CN); Hongwei Yuwen, Shenzhen (CN)

(21) Appl. No.: 14/454,474

(22) Filed: Aug. 7, 2014

Related U.S. Application Data
(63) Continuation of application No. PCT/CN2013/070869, filed on Jan. 23, 2013.

(30) Foreign Application Priority Data
Feb. 15, 2012 (CN) 201210034021.6

(51) Int. Cl. G06F 21/36

(52) U.S. Cl. CPC G06F 21/36
USPC 726/19

(57) ABSTRACT

The present disclosure discloses an unlocking method and device, a password setting method and device, relating to the technical field of computers. The unlocking method comprises the following steps of: displaying at least one password ring after a screen is activated; receiving, within a password selection region, a character generated from a slide operation to the password ring; and determining whether the received character is the same as a corresponding character in a preset password, and unlocking the screen if the received character is the same as the corresponding character in the preset password. In the present disclosure, introducing a password ring with characters to unlock a screen avoids the security problem that a trace remains on a screen in the case of a slide operation only, and also makes the use convenient for a user to reduce incorrect operations in inputting a password.

This application is a continuation application of International Application No. PCT/CN2013/070869, filed Jan. 23, 2013, which claims the benefit of Chinese Patent Application No. 2012100340216 on Feb. 15, 2012, and entitled “UNLOCKING METHOD AND DEVICE. PASSWORD SETTING METHOD AND DEVICE.” Each of these prior applications is incorporated herein by reference in its entirety.

### TECHNICAL FIELD

The disclosure relates to the technical field of computers, in particular to an unlocking method and device, a password setting method and device.

### BACKGROUND

With the continuous development of touch-screen technology, the development of touch-screen terminals (for example, touch-screen mobile phones, touch-screen personnel computers, etc.) by various manufacturers becomes deeper and deeper. In general, as there may be much private information stored in a touch-screen terminal, a user usually locks the touch-screen terminal when the touch-screen terminal is not in use in order to protect the private information. Correspondingly, when in need of operating an application in the touch-screen terminal, a user needs to unlock the screen of the touch-screen terminal via an unlocking operation at first thus to enter the application interface of the touch-screen terminal.

There are two securer unlocking ways in the prior art.

First Unlocking Way

In the case that the screen of a touch-screen terminal is locked, there are several selectable regions displayed on the interface of the touch-screen terminal after the interface of the touch-screen terminal is activated, as shown in FIG. 1. An unlocking operation is performed by selecting the above selectable regions according to a preset slide path, for example, by selecting all selectable regions in the first row from left to right, then moving to select the middle selectable region in the second row and finally selecting all selectable regions in the third row from left to right according to a Z-shaped sliding path. This technical solution has the following disadvantage that, as it is likely to leave a trace on the touch screen and the preset slide path is too simple and always kept unchanged when in use, others may get the slide path easily. Therefore, this unlocking way is low in security.

Second Unlocking Way

In the case that the screen of a touch-screen terminal is locked, after activating the interface of the touch-screen terminal, there is a prompt box for inputting an unlock password therein and simultaneously a series of characters for forming the password, such as numbers, letters or punctuations, displayed on the interface of the touch-screen terminal, as shown in FIG. 2. The touch-screen terminal may combine and input the characters (for example, number “2” in the figure) selected by a user into a fixed region for displaying the password. If the password is correct, the screen may be unlocked. This technical solution has the following disadvantage that, although it is securer to input a password, incorrect operations in inputting a password is likely to occur and the password input process is too complex as it is required to select the above characters one by one and it is very inconvenient to perform a selection operation on the touch-screen terminal.

During the implementation of the present disclosure, the inventor finds at least the following problems in the prior art: the unlocking ways are too simple and each of the unlocking ways has corresponding disadvantages as described above. Therefore, an improved technical solution is required to solve the above problems.

### SUMMARY

An object of the present disclosure is to provide an unlocking method and device, by which a password is input by sliding a password ring displayed on a screen to unlock the screen, so as to avoid the security problem that a trace remains on a screen in the case of a slide operation only, and also make the use convenient for a user to reduce incorrect operations in inputting a password.

Another object of the present disclosure is to provide a password setting method and device, by which a password is set for a touch-screen terminal according to a password sequence displayed on a screen, each password sequence being corresponding to a password ring mentioned in the above unlocking method and device; and after a password is set for a terminal, correspondingly, the set password may be unlocked by the unlocking method and device.

To realize the objects of the present disclosure, the embodiments of the present disclosure provide an unlocking method and device. The technical solutions are specifically as follows.

An unlocking method, comprising the following steps of:

displaying at least one password ring after a screen is activated; receiving, within a password selection region, a character generated from a slide operation to the password ring; and determining whether the received character is the same as a corresponding character in a preset password, and unlocking the screen if the received character is the same as the corresponding character in the preset password.

Further, the password ring is set with at least one character; and, said receiving, within a password selection region, a character generated from a slide operation to the password ring specifically includes the following steps of:

controlling the password ring to perform a slide operation according to a slide instruction from a user; and

when a character on the password ring slides via the slide operation into the password selection region and stops sliding, receiving the character.

Further, unlocking the screen includes the following steps of:

modifying a lock icon displayed on a screen into an unlock icon, and unlocking the screen when receiving a signal indicating that the unlock icon has been selected.

Still further, the password ring is a control to which a slide operation can be performed, and the character is set on the password ring in random arrangement every time a screen is activated.

An unlocking device is provided, comprising: a password ring display module, configured to display at least one password ring after a screen is activated; a character receiving module, configured to receive, within a password selection region, a character generated from a slide operation to the password ring; and an unlocking module, configured to determine whether the character received by the character receiving module is the same as a corresponding character in a preset password, and unlocking the screen if the received character is the same as the corresponding character in the preset password.

Further, the password ring is set with a plurality of characters; and, the character receiving module specifically includes:

a slide unit, configured to control the password ring to perform a slide operation according to a slide instruction from a user; and

a receiving unit, configured to, when a character on the password ring slides via the slide operation into the password selection region and stops sliding, receive the character.

Further, the unlocking module is specifically configured to: determine whether the received character is the same as a corresponding character in a preset password; and if the received character is the same as the corresponding character in the preset password, modify a lock icon displayed on a screen into an unlock icon, and unlock the screen when receiving a signal indicating that the unlock icon has been selected.

Further, the password ring is a control to which a slide operation can be performed, and the character is set on the password ring in random arrangement every time a screen is activated.

The technical solutions provided by the embodiments of the present disclosure have the following advantages:

inputting a password by sliding a password ring displayed on a screen, then comparing the input password with a preset password and finally unlocking the screen if the input password is the same as the preset password avoids the security problem that a trace remains on a screen in the case of a slide operation only, and also makes the use convenient for a user to reduce incorrect operations in inputting a password.

To realize the objects of the present disclosure, the present disclosure further provides a password setting method and device. The technical solutions are specifically as follows.

A password setting method is provided, comprising the following steps of: displaying at least one password sequence on a screen, the password sequence being set with a character or characters; receiving the character/characters selected from the password sequence; displaying, within a password display region, a password according to the character or characters received in turn; and receiving, within a password confirmation region, confirmation information in order to set the password.

A password setting device is provided, comprising: a password sequence display module, configured to display at least one password sequence on a screen, the password sequence being set with a character or characters; a character information receiving module, configured to receive the character or characters selected from the password sequence; a password display module, configured to display, within a password display region, a password according to the character or characters received in turn; and a password setting module, configured to receive, within a password confirmation region, confirmation information in order to set the password.

The technical solutions provided by the embodiments of the present disclosure have the following advantages:

a password is set for a touch-screen terminal according to a password sequence displayed on a screen, each password sequence being corresponding to a password ring mentioned in the above unlocking method and device; and after a password is set for a terminal, correspondingly, the set password may be unlocked by the unlocking method and device.

### BRIEF DESCRIPTION OF THE DRAWINGS

To describe the technical solutions in the embodiments of the present disclosure more clearly, the accompanying drawings to be used for describing the embodiments will be briefly introduced as below. Apparently, the accompanying drawings in the following description show merely some embodiments of the present disclosure, and a person of ordinary skill in the art may still derive other drawings from these accompanying drawings without creative efforts.

FIG. 1 is a schematic diagram of unlocking according to a slide path in the prior art;

FIG. 2 is a schematic diagram of unlocking by inputting a password in the prior art;

FIG. 3 is a flowchart of an unlocking method according to Embodiment 1 of the present disclosure;

FIG. 4 is a schematic diagram of a first screen containing a password ring when a touch-screen terminal is unlocked according to Embodiment 1 of the present disclosure;

FIG. 5 is a schematic diagram of a second screen containing a password ring when a touch-screen terminal is unlocked according to Embodiment 1 of the present disclosure;

FIG. 6 is a schematic diagram of a third screen containing a password ring when a touch-screen terminal is unlocked according to Embodiment 1 of the present disclosure;

FIG. 7 is a schematic diagram of a fourth screen containing a password ring when a touch-screen terminal is unlocked according to Embodiment 1 of the present disclosure;

FIG. 8 is a schematic diagram of a fifth screen containing a password ring when a touch-screen terminal is unlocked according to Embodiment 1 of the present disclosure;

FIG. 9 is a schematic diagram of a sixth screen containing a password ring when a touch-screen terminal is unlocked according to Embodiment 1 of the present disclosure;

FIG. 10 is a schematic diagram of a seventh screen containing a password ring when a touch-screen terminal is unlocked according to Embodiment 1 of the present disclosure;

FIG. 11 is a schematic diagram of an eighth screen containing a password ring when a touch-screen terminal is unlocked according to Embodiment 1 of the present disclosure;

FIG. 12 is a structure diagram of an unlocking device according to Embodiment 2 of the present disclosure;

FIG. 13 is a flowchart of a password setting method according to Embodiment 3 of the present disclosure;

FIG. 14 is a schematic diagram of a first screen when a password is set according to Embodiment 3 of the present disclosure;

FIG. 15 is a schematic diagram of a second screen when a password is set according to Embodiment 3 of the present disclosure;

FIG. 16 is a schematic diagram of a third screen when a password is set according to Embodiment 3 of the present disclosure;

FIG. 17 is a schematic diagram of a fourth screen when a password is set according to Embodiment 3 of the present disclosure; and

FIG. 18 is a structure diagram of a password setting device according to Embodiment 4 of the present disclosure.

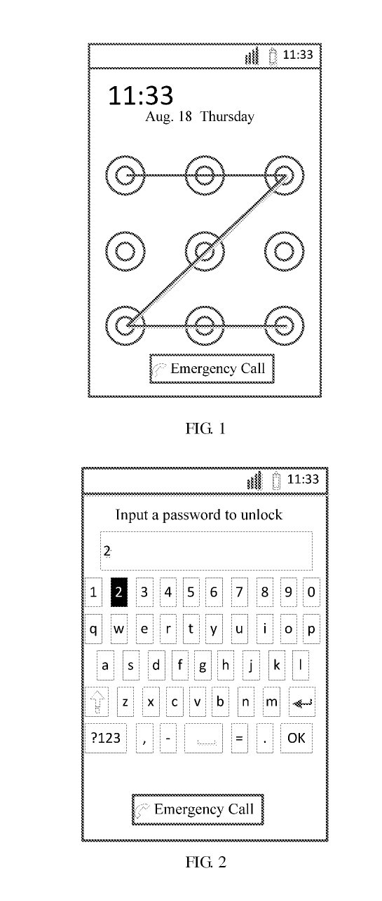

### DETAILED DESCRIPTION

To make the objects, technical solutions and advantages of the present disclosure clearer, the implementation ways of the present disclosure will be further described as below in details with reference to the accompanying drawings. “Several” used here refers to one or more than one, “a plurality of” used herein refers to more than one, and “at least one” used herein refers to one or more than one.

### Embodiment 1

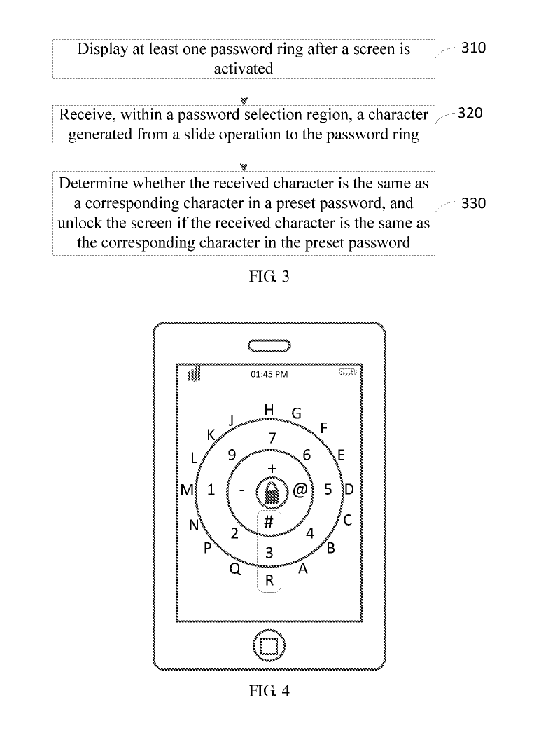

FIG. 3 is a flowchart of an unlocking method according to Embodiment 1 of the present disclosure. The unlocking method provided by this embodiment may be applied to a terminal with a touch screen, for example, a touch-screen mobile phone, a touch-screen personnel computer, etc. The unlocking method includes the following steps:

Step 310: At least one password ring is displayed after a screen is activated.

In general, in order to enter an application interface of a touch-screen terminal when the touch-screen terminal is locked, it is required to input a preset password. Generally, the password mentioned here may be a character string, wherein the character may include punctuations, numbers, letters, etc. When a user wants to unlock the screen by a password, he/she needs to tap the screen to activate the screen at first. At this moment, at least one password ring will be displayed on the screen.

Preferably, after the screen is activated, each password ring displayed on the screen may contain a plurality of characters, and the characters on the password ring displayed on the screen may be set in random arrangement every time the screen is activated.

In practices, the password ring may be in different shapes, referring to FIG. 4 to FIG. 11, wherein the password rings shown in FIG. 4 to FIG. 7 are concentrically circular password rings; and the innermost password ring may be defined as a first password ring, the middle password ring may be defined as a second password ring, and the outermost password ring may be defined as a third password ring. The password rings shown in FIG. 8 to FIG. 11 are linear password rings; and the uppermost password may be defined as a first password ring, the middle password ring may be defined as a second password ring, and the lowermost password ring may be defined as a third password ring.

The arrangement order or selection order of the password rings may be associated with an order of characters in a preset password. For example, the arrangement order or selection order of the password rings may be corresponding to the order of characters in the preset password. Specifically, the first character of the password is usually corresponding to the characters on the first password ring, the second character of the password is usually corresponding to the characters on the second password ring, and the third character of the password is usually corresponding to the characters on the third password ring.

To ensure the convenience in selecting characters, usually, each password ring may be set with characters of a same type. For example, all characters on the first password ring are punctuations, all characters on the second password ring are numbers, and all characters on the third password ring are letters.

Certainly, in practices, the number of password rings may not be just three as described above. There may be one, two or more than three password rings. That is to say, the number of password rings may be the same as the number of characters in the preset password. This is because, if the preset password consists of four characters, four password rings may be required. For example, if the preset password is “+1AB”, four password rings may be set in this case, wherein the first password ring is set with different punctuations, the second password ring is set with different numbers, the third password ring is set with different letters, and the fourth password ring is set with different letters. Of course, characters in each password ring are not just limited to the above condition. For example, characters in each password ring may contain punctuations, numbers, letters and other characters simultaneously, but it is required to ensure that each password ring contains a character the same as the character at a corresponding position in the password.

It is to be noted that, for the password rings as shown in FIG. 8 to FIG. 11, limited by the width or height of a screen, all characters on the password rings may not be displayed on the screen one time. In this case, the password rings may be set as sliding password rings. Via a slide operation, the characters on the password rings, which are not displayed, can be displayed now. As this sliding technology can be implemented by a person of ordinary skill in the art, it will not be described in detail here.

It is to be noted that the shape of the password rings is not just limited to that shown in FIG. 4 to FIG. 11. The password rings may also be set in other shapes which are easy to image. The shape of the password rings should not be regarded as a limitation to the protection scope of the embodiments of the present disclosure.

Step 320: A character generated from a slide operation to the password ring is received within a password selection region.

The setup of the password selection region may comprise the following two conditions:

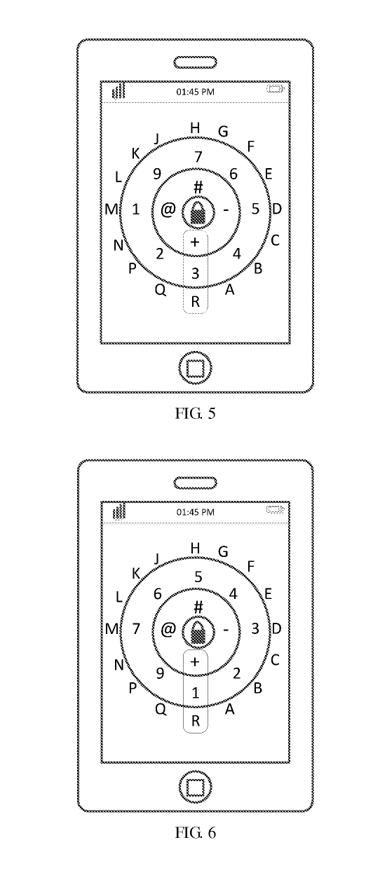

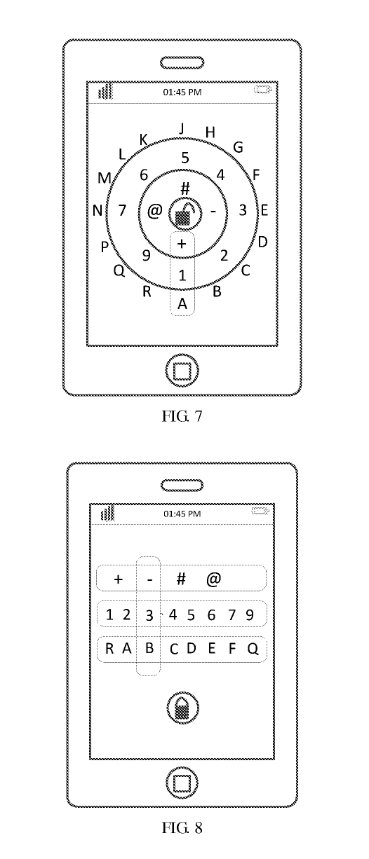

Firstly, the password selection region may be preset in a fixed region of the screen, for example, as shown in FIG. 4. In this case, a user needs to slide each password ring to rotate a desirable character on the password ring into the password selection region. That is to say, the password ring is controlled to perform a slide operation according to a slide instruction of the user, when a character on the password ring slides to the fixed password selection region via the slide operation and stops sliding, the character is received. For example, if the preset password is “+1A”, the user may slide the first password ring to slide “+” into the password selection region, as shown in FIG. 5; then, slide the second password ring to slide “1” into the password selection region, as shown in FIG. 6; and finally, slide the third password ring to slide “A” into the password selection region, as shown in FIG. 7. The above condition indicates that the order of sliding the password rings is associated with the order of characters in the password. That is, the order of sliding the password rings is corresponding to the order of characters in the password. Certainly, the order of sliding the password rings may not be the order of characters in the password. In this case, it is only required to rotate and slide a character in each password ring, which is corresponding to the character in the password, into the password selection region. That is, no order may be set for each password ring. For example, one of the password rings may be slid arbitrarily to slide the character corresponding to the first character in the password into the password selection region, and then, any one of the remaining password rings is slid arbitrarily to slide the character corresponding to the second character in the password into the password selection region, and so forth. It is to be noted, in the case that the password selection region is preset in a fixed region of the screen, each password ring may be set as a password ring that can be rotated or slid.

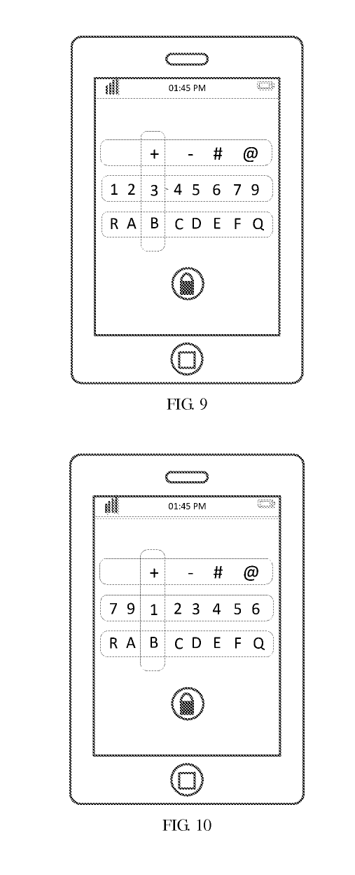

Secondly, the password selection region may also be set after a character in one of the password rings, which is corresponding to the first character of the password, has been selected, for example, as shown in FIG. 4. In this case, the first password ring may be set as a password ring that can not be rotated or slid (may be called a fixed password ring), while the second and third password rings may be set as password rings that can be rotated or slid (a password ring that can be rotated or slid may be implemented by a control which should be set with all characters on the password ring). A user may select a corresponding character on the first password ring according to the first character of the password. At this moment, a password selection region is generated according to the position of the selected character. The password selection region shown in FIG. 5 is in a shape radiated outward along the radius of the first password ring by taking the position of the selected character on the first password ring as a starting point. The password selection region is extended outside the circle of the outermost password ring (i.e., the third password ring in FIG. 4 to FIG. 7) in length so as to cover the characters on the outermost password ring. For another example, referring to FIG. 8, the first password ring may be set as a password ring that can not be slid (may called a fixed password ring), while the second and third password rings may be set as password rings that can be slid. A user may select a corresponding character on the first password ring according to the first character of the password, at this moment, a password selection region is generated according to the position of the selected character. The password selection region shown in FIG. 9 is a region extended to the lowermost password ring by taking the position of the selected character on the first password ring as a starting point. The password selection region is extended beyond the lowermost password ring (the third password ring in FIG. 8 to FIG. 11) in length so as to cover the characters on the lowermost password ring. After a password selection region is generated, the operable password rings are rotated or slid in order to slide corresponding characters in the password into the selection region. That is, the password rings are controlled to perform a slide operation according to a slide instruction of a user. When a character on a password ring is slid to the password selection operation via a slide operation and stops sliding, the character is received. Usually, a character selected from a fixed password ring may be the first character in the preset password, and characters on the remaining operable password rings may be selected similarly to the above description. That is, the order of selecting characters from the operable password rings may be or may not be associated with the order of characters in the password.

In practices, a user may slide a plurality of characters on a password ring into a password selection region more than one time. Usually, for each password ring, only one character is selected as the corresponding character in the password. Preferably, a character on the password ring, which is slid into the password selection region the last time, may be used as the selected character.

Step 330: It is determined whether the received character is the same as a corresponding character in a preset password, and unlocking the screen if the received character is the same as the corresponding character in the preset password.

In a preferred embodiment, it is necessary to determine whether each received character is the same as a corresponding character in the preset password. If all received characters are the same as corresponding characters in the preset password, a lock icon displayed on the screen is modified into an unlock icon, and the screen is unlocked when receiving a signal indicating that the unlock icon has been selected.

When the order of sliding password rings to a password selection region is corresponding to the order of characters in the password, the characters slid to the password selection region are compared with the corresponding characters in the password in turn. When all the characters in turn slid into the password selection region are corresponding to the characters in the password one by one, the screen is unlocked. Usually, when it is found by comparison that all the characters within the password selection region are the same as the characters in the password one by one, the screen may be unlocked. At this moment, a lock icon for unlocking may be displayed on the screen. The priority of turning this icon into the unlock state is relatively low. That is, the lock icon can be turned into the unlock state (which may be interpreted as modifying the lock icon into the unlock icon) only when all the received characters are the same as the corresponding characters in the password. When the lock icon is turned into the unlock state, that is, when the lock icon is modified into the unlock icon, the screen is unlocked if a user selects or clicks the lock icon, that is, if receiving a signal indicating that the unlock icon has been selected.

In conclusion, the unlocking method provided by Embodiment 1 of the present disclosure receives a password by sliding password rings displayed on the screen, compares the received password with a preset password, and unlocks the screen if the received password is the same as the preset password, thus to avoid the security problem that a trace remains on a screen in the case of a slide operation only and also make the use convenient for a user to reduce incorrect operations in inputting a password.

### Embodiment 2

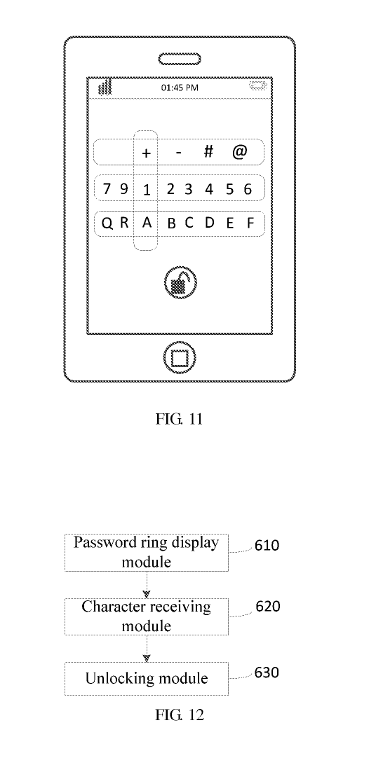

FIG. 12 is a structure diagram of an unlocking device according to Embodiment 2 of the present disclosure. The unlocking device provided by this embodiment may be applied to a terminal with a touch screen, for example, a touch-screen mobile phone, a touch-screen personnel computer, etc. The unlocking device includes a password ring display module 610, a character receiving module 620 and an unlocking module 630.

The password ring display module 610 is configured to display at least one password ring after a screen is activated.

In general, in order to enter an application interface of a touch-screen terminal when the touch-screen terminal is locked, it is required to input a preset password. Generally, the password mentioned here may be a character string, wherein the character may include punctuations, numbers, letters, etc. When a user wants to unlock the screen by a password, he/she needs to tap the screen to activate the screen at first. At this moment, at least one password ring will be displayed on the screen.

Preferably, after the screen is activated, each password ring displayed on the screen may contain a plurality of characters, and the characters on the password ring displayed on the screen may be set in random arrangement every time the screen is activated.

In practices, the password ring may be in different shapes, referring to FIG. 4 to FIG. 11, wherein the password rings shown in FIG. 4 to FIG. 7 are concentrically circular password rings; and the innermost password ring is the first password ring, the middle password ring is the second password ring, and the outermost password ring is the third password ring. The password rings shown in FIG. 8 to FIG. 11 are linear password rings; and the uppermost password is the first password ring, the middle password ring is the second password ring, and the lowermost password ring is the third password ring. The arrangement order or selection order of the password rings is associated with an order of characters in a preset password. For example, the first character of the password is usually corresponding to the characters on the first password ring, the second character of the password is usually corresponding to the characters on the second password ring, and the third character of the password is usually corresponding to the characters on the third password ring.

To ensure the convenience in selecting characters, usually, each password ring may be set with characters of a same type. For example, all characters on the first password ring are punctuations, all characters on the second password ring are numbers, and all characters on the third password ring are letters. Certainly, in practices, the number of password rings may not be just three as described above. There may be two password rings or more than three password rings. That is to say, the number of password rings may be the same as the number of characters in the preset password. The reason is that, if the preset password consists of four characters, four password rings may be required. For example, if the preset password is “+1AB”, four password rings may be set in this case, wherein the first password ring is set with different punctuations, the second password ring is set with different numbers, the third password ring is set with different letters, and the fourth password ring is set with different letters. Of course, characters in each password ring are not just limited to the above condition. For example, characters in each password ring may contain punctuations, numbers, letters and other characters simultaneously, but it is required to ensure that each password ring contains a character the same as the character at a corresponding position in the password.

It is to be noted that, for the password rings as shown in FIG. 8 to FIG. 11, limited by the width or height of a screen, all characters on the password rings may not be displayed on the screen one time. In this case, the password rings may be set as sliding password rings. Via a slide operation, the characters on the password rings, which are not displayed, can be displayed now. As this sliding technology can be implemented by a person of ordinary skill in the art, it will not be described in detail here.

It is to be noted that the shape of the password rings is not just limited to that shown in FIG. 4 to FIG. 11. The password rings may also be set in other shapes which are easy to image. The shape of the password rings should not be regarded as a limitation to the protection scope of the present disclosure.

The character receiving module 620 is configured to receive, within a password selection region, a character generated from a slide operation to the password ring. The character receiving module 620 comprises a slide unit and a receiving unit. The slide unit is configured to control the password ring to perform a slide operation according to a slide instruction from a user. The receiving module is configured to instruct the password selection region to receive the character when a character on the password ring slides via the slide operation into the password selection region and stops sliding.

The setup of the password selection region may comprise the following two conditions:

Firstly, the password selection region may be preset in a fixed region of the screen, for example, as shown in FIG. 4. In this case, a user needs to slide each password ring to rotate a desirable character on the password ring into the password selection region. That is, the password ring is controlled to perform a slide operation according to a slide instruction of the user. When a character on the password ring slides to the fixed password selection region via the slide operation and stops sliding, the character is received. For example, if the preset password is “+1A”, the user may slide the first password ring to slide “+” into the password selection region, as shown in FIG. 5; then, slide the second password ring to slide “1” into the password selection region, as shown in FIG. 6; and finally, slide the third password ring to slide “A” into the password selection region, as shown in FIG. 7. The above condition indicates that the order of sliding the password rings is associated with the order of characters in the password. Of course, the order of sliding the password rings may not represent the order of characters in the password. In this case, it is only required to rotate and slide a character in each password ring, which is corresponding to the character in the password, into the password selection region. That is, no order may be set for each password ring. For example, one of the password rings may be slid arbitrarily to slide the character corresponding to the first character in the password into the password selection region, and then, any one of the remaining password rings is slid arbitrarily to slide the character corresponding to the second character in the password into the password selection region, and so forth. It is to be noted, in the case that the password selection region is preset in a fixed region of the screen, each password ring may be set as a password ring that can be rotated or slid.

Secondly, the password selection region may also be set after a character in one of the password rings, which is corresponding to the first character of the password, has been selected, for example, as shown in FIG. 4. In this case, the first password ring may be set as a password ring that can not be rotated or slid (may be called a fixed password ring), while the second and third password rings may be set as password rings that can be rotated or slid. A user may select a corresponding character on the first password ring according to the first character of the password. At this moment, a password selection region is generated according to the position of the selected character. The password selection region shown in FIG. 5 is in a shape radiated outward along the radius of the first password ring by taking the position of the selected character on the first password ring as a starting point. The password selection region is extended outside the circle of the outermost password ring (i.e., the third password ring in FIG. 4 to FIG. 7) in length so as to cover the characters on the outermost password ring. For another example, referring to FIG. 8, the first password ring may be set as a password ring that can not be slid (may called a fixed password ring), while the second and third password rings may be set as password rings that can be slid. A user may select a corresponding character on the first password ring according to the first character of the password. At this moment, a password selection region is generated according to the position of the selected character. The password selection region shown in FIG. 9 is a region extended to the lowermost password ring by taking the position of the selected character on the first password ring as a starting point. The password selection region is extended beyond the lowermost password ring (the third password ring in FIG. 8 to FIG. 11) in length so as to cover the characters on the lowermost password ring. After a password selection region is generated, the operable password rings are rotated or slid in order to slide corresponding characters in the password into the selection region. That is to say, the password rings are controlled to perform a slide operation according to a slide instruction of a user. When a character on a password ring is slid to the password selection operation via a slide operation and stops sliding, the character is received. At this moment, a character selected from a fixed password ring may be the first character in the preset password, and characters on the remaining operable password rings may be selected similarly to the above description. That is, the order of selecting characters from the operable password rings may be or may not be associated with the order of characters in the password.

The unlocking module 630 is configured to determine whether the received character is the same as a corresponding character in a preset password, and unlocking the screen if the received character is the same as the corresponding character in the preset password.

In a preferred embodiment, it is necessary to determine whether each received character is the same as a corresponding character in the preset password. If all received characters are the same as corresponding characters in the preset password, a lock icon displayed on the screen is modified into an unlock icon, and the screen is unlocked when receiving a signal indicating that the unlock icon has been selected.

When the order of sliding password rings into a password selection region is associated to the order of characters in the password, the characters slid to the password selection region are compared with the corresponding characters in the password in turn. When all the characters in turn slid into the password selection region are corresponding to the characters in the password one by one, the screen is unlocked. Usually, when it is found by comparison that all the characters within the password selection region are the same as the characters in the password one by one, the screen may be unlocked. At this moment, a lock icon for unlocking may be displayed on the screen. The priority of turning this icon into the unlock state is relatively low. That is to say, the lock icon can be turned into the unlock state (which may be interpreted as modifying the lock icon into the unlock icon) only when all the received characters are the same as the corresponding characters in the password. When the lock icon is turned into the unlock state, that is, when the lock icon is modified into the unlock icon, the screen is unlocked if a user selects or clicks the lock icon, that is, if receiving a signal indicating that the unlock icon has been selected.

It is to be noted that, the unlocking device provided by this embodiment is illustrated through the division of the above all functional modules by way of example only when the embodiments of the present disclosure are described. However, in practices, the above functions may be implemented by different functional modules according to actual need, that is, the internal structures of the device may be divided into different functional modules for completing all or part of the functions described above. In addition, the unlocking device provided by this embodiment and the embodiment of the unlocking method are based on the same idea. The specific implementation process is disclosed in the embodiment of the method and will not be repeated here.

In conclusion, the unlocking device provided by Embodiment 2 of the present disclosure receives a password by sliding password rings displayed on the screen, compares the received password with a preset password, and unlocks the screen if the received password is the same as the preset password, thus it can avoid the security problem that a trace remains on a screen in the case of a slide operation only and it can also make the use convenient for a user to reduce incorrect operations in inputting a password.

With regard to the above unlocking technology, it is required to set a corresponding password on a touch-screen terminal at first, so that a user can unlock the screen via the password. The process of setting a password for a touch-screen terminal may refer to the descriptions given in reference to FIG. 13 to FIG. 19.

### Embodiment 3

FIG. 13 is a flowchart of a password setting method according to Embodiment 3 of the present disclosure. The password setting method provided by this embodiment may be applied to a terminal with a touch screen, for example, a touch-screen mobile phone, a touch-screen personnel computer, etc. The password setting method includes the following steps:

Step 710: At least one password sequence is displayed on a screen, the password sequence being set with a character or characters.

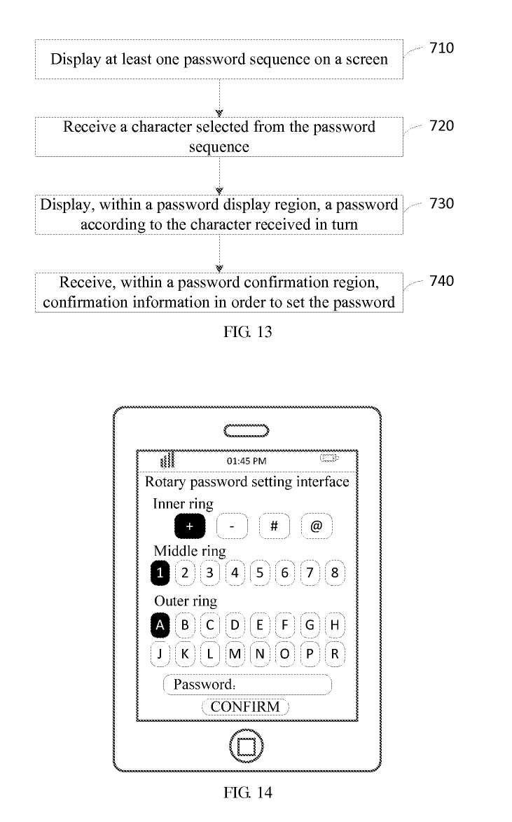

In general, the number of password sequences is associated with the number of characters in a password. For example, the number of password sequences is the same as the number of characters in a password. Specifically, when there are 3 password sequences, there may be 3 characters set in the password. Each password sequence may consist of characters of a same type. Referring to FIG. 14, the first password sequence (inn ring) consists of punctuations only, the second password sequence (middle ring) consists of numbers only, and the third password sequence (outer ring) consists of letters only. In practices, the password sequence when a password is set is corresponding to the password ring when the password is unlocked one by one. For example, the inner ring may be corresponding to the innermost password ring in FIG. 4 to FIG. 7 when the password is unlocked, the middle ring may be corresponding to the middle password in FIG. 4 to FIG. 7 when the password is unlocked, and the outer ring may be corresponding to the outermost password ring in FIG. 4 to FIG. 7 when the password is unlocked.

In general, the password sequence may be set as a control that can be slid, and the control is set with several characters thereon. Correspondingly, for each password sequence, all characters on the password sequence may be pulled via a slide operation. For example, if the first character in the password must be punctuation, the password sequence for setting this character needs to contain all punctuations likely to be set, thus all punctuations on the password sequence may be pulled by pulling the password sequence. Alternatively, the password sequence may be set as a combination of several controls that can not be slid, and each of the controls is set with characters. Correspondingly, each password sequence needs to display and contain all characters likely to be set in the password. For example, if the first character in the password is punctuation, the password sequence for setting the first character in the password needs to display all punctuations one time.

In addition, each password sequence may also be formed by combining punctuations, numbers and letters. In this case, the set password may have same characters.

Step 720: A character or characters selected from the password sequence is received.

When a user selects a character from each password sequence, an internal processor of the touch-screen terminal may receive the character selected from each password sequence.

Step 730: A password is displayed within a password display region according to the character or characters received in turn.

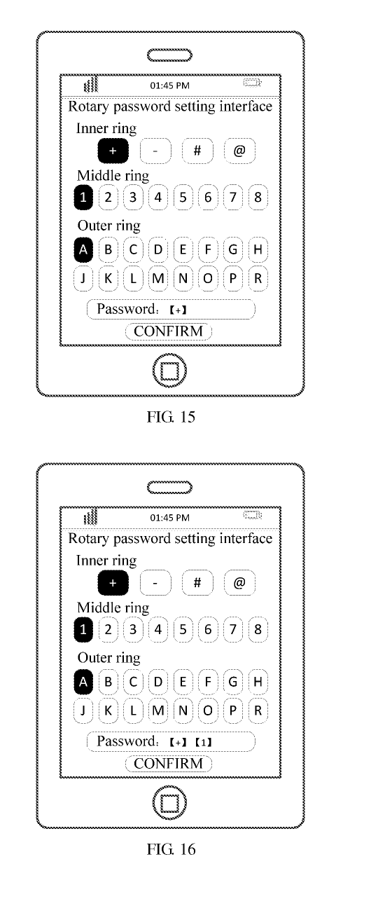

In general, a user may select characters on password sequences according to an order of the password sequences. For example, the first character in the password is valid only when selected from the first password sequence, and the second character in the password is valid only when selected from the second password sequence, and so forth. For example, in the password as shown in FIG. 14, the first character “+” is valid only when selected from the first password sequence (inner ring), as shown in FIG. 15; the second character “1” is valid only when selected from the second password sequence (middle ring), as shown in FIG. 16; and, the third character “A” is valid only when selected from the third password sequence (outer ring), as shown in FIG. 17.

Certainly, the display of a password may also be independent from the order of the password sequences. A first character selected from one of the password sequences may be used as the first character in the password, and a second character selected from a password sequence other than the above password sequence may be used as the second character in the password, and so forth. For example, if the character “2” in the second password sequence is selected at the first time, the character “+” in the first password sequence is selected at the second time, and the character “A” in the third password sequence is selected at the third time, thus the resulting preset password is “2+A”.

Usually, to ensure that characters on each password ring are corresponding to characters in password sequences one by one, only one character can be selected from each password sequence as a character forming the password. For example, if two characters in a same password sequence are selected successively, only the later one is used as a character forming the password. For another example, a plurality of characters in the same password sequence is selected successively, only the last one is used as the character forming the password.

Step 740: Acknowledgement information is received within a password confirmation region in order to set the password.

The password confirmation region may be a button CONFIRM which is used for confirming operation. When the password displayed within the password confirmation region is a password to be set by a user, the user may select or click the password confirmation region (that is, the password confirmation region receives confirmation information) in order to set the above password. After setting, it is required to input the password to unlock the screen when the touch-screen terminal needs to be unlocked.

In conclusion, the password setting method provided by Embodiment 3 of the present disclosure may set a password on a screen with regard to different password sequences, and is used in accompanying with the unlocking technology described above. That is, the above password sequences are mapped to the password rings one by one. As a result, the touch-screen terminal is unlocked by a password. This not only avoids the security problem that a trace remains on a screen in the case of a slide operation only, but also makes the use convenient for a user to reduce incorrect operations in inputting a password.

### Embodiment 4

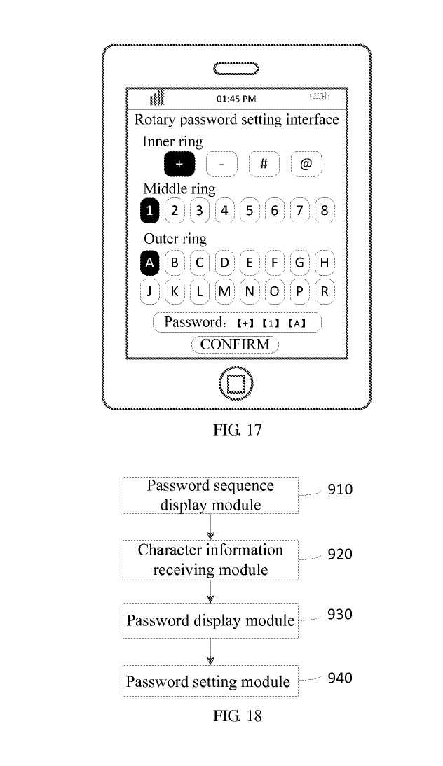

FIG. 18 is a structure diagram of a password setting device according to Embodiment 4 of the present disclosure. The password setting device provided by this embodiment may be applied to a terminal with a touch screen, for example, a touch-screen mobile phone, a touch-screen personnel computer, etc. The password setting device includes a password sequence display module 910, a character information receiving module 920, a password display module 930 and a password setting module 940.

The password sequence display module 910 is configured to display at least one password sequence on a screen.

In general, the number of password sequences is associated with the number of characters in a password. For example, when there are 3 password sequences, there may be 3 characters set in the password. Each password sequence may consist of characters of a same type. Referring to FIG. 14, the first password sequence (inn ring) consists of punctuations only, the second password sequence (middle ring) consists of numbers only, and the third password sequence (outer ring) consists of letters only. In practices, the password sequence when a password is set is corresponding to the password ring when the password is unlocked one by one. For example, the inner ring may be corresponding to the innermost password ring in FIG. 4 to FIG. 7 when the password is unlocked, the middle ring may be corresponding to the middle password in FIG. 4 to FIG. 7 when the password is unlocked, and the outer ring may be corresponding to the outermost password ring in FIG. 4 to FIG. 7 when the password is unlocked.

In another embodiment, each password sequence may also be formed by combining punctuations, numbers and letters.

The character information receiving module 920 is configured to receive a character or characters selected from a password sequence, the password sequence being set with a character or characters.

The password display module 930 is configured to display, within a password display region, a password according to the characters received in turn.

In general, a user may select characters on password sequences according to an order of the password sequences. For example, the first character in the password is valid only when selected from the first password sequence, and the second character in the password is valid only when selected from the second password sequence, and so forth. For example, in the password as shown in FIG. 14, the first character “+” is valid only when selected from the first password sequence (inner ring), as shown in FIG. 15; the second character “1” is valid only when selected from the second password sequence (middle ring), as shown in FIG. 16; and, the third character “A” is valid only when selected from the third password sequence (outer ring), as shown in FIG. 17.

Certainly, the display of a password may also be independent from the order of the password sequences. A first character selected from one of the password sequences may be used as the first character in the password, and a second character selected from a password sequence other than the above password sequence may be used as the second character in the password, and so forth. For example, if the character “2” in the second password sequence is selected at the first time, the character “+” in the first password sequence is selected at the second time, and the character “A” in the third password sequence is selected at the third time, thus the resulting preset password is “2+A”.

Usually, to ensure that characters on each password ring are corresponding to characters in password sequences one by one, only one character can be selected from each password sequence as a character forming the password. For example, if two characters in a same password sequence are selected successively, only the later one is used as a character forming the password. For another example, several characters in a same password sequence are selected successively, only the last one is used as a character forming the password.

The password setting module 940 is configured to receive, within a password confirmation region, confirmation information in order to set the password.

The password confirmation region may be a button CONFIRM which is used for confirming operation. When the password displayed within the password confirmation region is a password to be set by a user, the user may select or click the password confirmation region in order to set the above said password. After setting, it is required to input the password to unlock the screen when the touch-screen terminal needs to be unlocked.

It is to be noted that, the password setting device provided by this embodiment is illustrated through the division of the above all functional modules by way of example only when the embodiments of the present disclosure are described. However, in practices, the above functions may be implemented by different functional modules according to actual need, that is, the internal structures of the device may be divided into different functional modules for completing all or part of the functions described above. In addition, the password setting device provided by this embodiment and the embodiment of the password setting method are based on the same idea. The specific implementation process is disclosed in the embodiment of the method and will not be repeated here.

In conclusion, the password setting device provided by Embodiment 4 of the present disclosure may set a password on a screen with regard to different password sequences, and is used in accompanying with the unlocking technology described above. That is, the above password sequences are mapped to the password rings one by one. As a result, the touch-screen terminal is unlocked by a password. This avoids the security problem that a trace remains on a screen in the case of a slide operation only and also makes the use convenient for a user to reduce incorrect operations in inputting a password.

A person of ordinary skill in the art may understand that all or a part of the steps of the foregoing embodiments may be implemented by hardware or a program instructing related hardware. The program may be stored in a computer readable storage medium. The storage medium may be a read-only memory, a magnetic disk, an optical disk, etc.

The foregoing descriptions are merely preferred embodiments of the present disclosure, and are not intended to limit the present disclosure. Any modification, equivalent replacement and improvement made within the spirit and principle of the present disclosure shall fall into the protection scope of the present disclosure.

What is claimed is:

1. An unlocking method, comprising:
displaying at least one password ring after a screen is activated;
receiving, within a password selection region, a character generated from a slide operation to the password ring; and
determining whether the received character is the same as a corresponding character in a preset password, and unlocking the screen if the received character is the same as the corresponding character in the preset password.

2. The unlocking method according to claim 1, wherein the password ring is set with at least one character; and,
receiving, within a password selection region, a character generated from a slide operation to the password ring specifically comprises the following steps of:
controlling the password ring to perform a slide operation according to a slide instruction from a user; and
when a character on the password ring slides via the slide operation into the password selection region and stops sliding, receiving the character.

3. The unlocking method according to claim 1, wherein unlocking the screen comprises the following steps of:
modifying a lock icon displayed on a screen into an unlock icon, and unlocking the screen when receiving a signal indicating that the unlock icon has been selected.

4. The unlocking method of claim 1, wherein the password ring is a control to which a slide operation can be performed, and the character is set on the password ring in random arrangement every time a screen is activated.

5. The unlocking method of claim 2, wherein the password ring is a control to which a slide operation can be performed, and the character is set on the password ring in random arrangement every time a screen is activated.

6. The unlocking method of claim 3, wherein the password ring is a control to which a slide operation can be performed, and the character is set on the password ring in random arrangement every time a screen is activated.

7. An unlocking device, comprising:
a password ring display module, configured to display at least one password ring after a screen is activated;
a character receiving module, configured to receive, within a password selection region, a character generated from a slide operation to the password ring; and
an unlocking module, configured to determine whether the character received by the character receiving module is the same as a corresponding character in a preset password, and unlocking the screen if the received character is the same as the corresponding character in the preset password.

8. The unlocking device according to claim 7, wherein the password ring is set with at least one character; and, the character receiving module specifically comprises:
a slide unit, configured to control the password ring to perform a slide operation according to a slide instruction from a user; and
a receiving unit, configured to, when a character on the password ring slides via the slide operation into the password selection region and stops sliding, receive the character.

9. The unlocking device according to claim 7, wherein the unlocking module is specifically configured to:
determine whether the received character is the same as a corresponding character in a preset password; and if the received character is the same as the corresponding character in the preset password, modify a lock icon displayed on a screen into an unlock icon, and unlock the screen when receiving a signal indicating that the unlock icon has been selected.

10. The unlocking device of claim 7, wherein the password ring is a control to which a slide operation can be performed, and the character is set on the password ring in random arrangement every time a screen is activated.

11. The unlocking device of claim 8, wherein the password ring is a control to which a slide operation can be performed, and the character is set on the password ring in random arrangement every time a screen is activated.

12. The unlocking device of claim 9, wherein the password ring is a control to which a slide operation can be performed, and the character is set on the password ring in random arrangement every time a screen is activated.

13. A password setting method, wherein the method comprises:
displaying at least one password sequence on a screen, the password sequence being set with a character or characters;
receiving a character or characters selected from the password sequence;
displaying, within a password display region, a password according to the character or characters received in turn; and
receiving, within a password confirmation region, confirmation information in order to set the password.

14. A password setting device, wherein the device comprises:
a password sequence display module, configured to display at least one password sequence on a screen, the password sequence being set with a character or characters;
a character information receiving module, configured to receive a character or characters selected from the password sequence;
a password display module, configured to display, within a password display region, a password according to the character or characters received in turn; and
a password setting module, configured to receive, within a password confirmation region, confirmation information in order to set the password.
